(19) United States
(12) Patent Application Publication
(10) Pub. No.: US 2008/0083210 A1
(43) Pub. Date: Apr. 10, 2008

(54) MONOLITHIC THRUST REVERSER COMPONENTS

(75) Inventors: Joe E. Sternberger, Wichita, KS (US); Christopher Sawyer, Udall, KS (US)

Correspondence Address: HOVEY WILLIAMS LLP, 10801 Mastin Blvd., Suite 1000, Overland Park, KS, 66210, US

(73) Assignee: SPIRIT AEROSYSTEMS, INC, Wichita, KS (US)

(21) Appl. No.: 11/538,727

(22) Filed: Oct. 4, 2006

(51) Int. Cl. F02K 1/00

(52) U.S. Cl. 60/230

(57) ABSTRACT

An aircraft engine (10) includes a pivot-door type thrust reverser (22) located at an aft portion of a nacelle (16). The thrust reverser (22) includes a monolithic fan duct barrel (24) with an annular wall (50) that includes a forward section (46), a door section (54), and an aft section (48). The wall (50) has a honeycomb-sandwich type structure with an interior face sheet (60) and a backing sheet (62) radially separated by a first cellular core (66). An outer sheet (64) associated with the aft section (48) of the wall (50) is radially separated from the backing sheet (62) by a second cellular core (68). A plurality of pivoting doors (26,28) mate with a plurality of door openings (56,58) in the door section (54) of the annular wall (50). Each door (26,28) has honeycomb-sandwich type structure similar to that of the annular wall (50), wherein each door (26,28) has an interior face sheet (74) separated from a backing sheet (76) by a first cellular core (80), and an outer sheet (78) separated from the backing sheet (76) by a second cellular core (82).

### BACKGROUND OF THE INVENTION

1. Field of the Invention

Embodiments of the present invention relate to the field of thrust reversers for jet aircraft engines. More particularly, embodiments of the invention involve a pivot-door type thrust reverser compromising a monolithic fan duct barrel and a plurality of monolithic pivot doors.

2. Description of Prior Art

Airplanes driven by jet engines have high landing speeds, which can place a heavy burden on the planes' wheel breaks and tires during landing runs. To reduce this burden, most jet-driven airplanes are provided with means to reverse the direction of flow of the jet stream during landing runs to produce a reverse thrust, thus slowing the airplane with the jet engines as opposed to the wheel breaks.

Many different types of thrust reversers have been developed for this purpose, all based on the principle of blocking rearward flow of the jet stream and diverting the jet stream flow laterally, forwardly, or both. One type of thrust reverser, called the pivot-door type, uses openings in the side wall of the nacelle together with blocker doors which swing toward the engine access to block rearward flow and extend outward to direct the diverted flow laterally and forwardly.

Unfortunately, existing pivot door type thrust reversers are constructed of a complex array of mechanically interconnected parts. These doors are costly, heavy, and limit the available surface acoustic area that can be used to reduce engine noise.

Accordingly, there is a need for an improved aircraft engine thrust reverser that does not suffer from the problems and limitations of the prior art.

### SUMMARY OF THE INVENTION

Embodiments of the present invention provide an improved thrust reverser for jet aircraft engines that does not suffer from the problems and limitations of the prior art. Particularly, the embodiments of the present invention provide a thrust reverser with a monolithic fan duct barrel and a plurality of monolithic thrust reverser doors that reduce the overall weight and complexity of the thrust reverser and increase the available acoustic area of the thrust reverser.

According to a first embodiment, the thrust reverser comprises a monolithic fan duct barrel with an annular wall that defines a plurality of door openings, wherein the wall includes an interior face sheet and a backing sheet radially separated by a first cellular core.

According to a second embodiment, a nacelle for a jet engine comprises a fan cowl defining a first portion of a fan duct and a monolithic fan duct barrel with a wall that defines a second portion of the fan duct and a plurality of door openings. The wall includes a continuously annular forward section, a continuously annular aft section, and a door section between the forward section and the aft section, wherein the door section defines the door openings, and wherein the wall includes an interior face sheet and a backing sheet radially separated by a first cellular core.

According to a third embodiment, the nacelle comprises a fan cowl defining a first portion of a fan duct and a monolithic fan duct barrel with a wall that defines a second portion of the fan duct and defines a plurality of door openings, wherein the wall includes a continuously annular forward section, a continuously annular aft section, and a door section between the forward section and the aft section, wherein the door section defines the door openings.

According to a fourth embodiment, an aircraft engine comprises a jet engine and a nacelle at least partially enclosing the engine, wherein the nacelle includes an aft thrust reverser. The thrust reverser includes a monolithic fan duct barrel and a pair of monolithic doors. The fan duct barrel includes an annular wall presenting opposed first and second door openings, wherein the wall includes an interior face sheet of material and a backing sheet of material separated by a first cellular core, wherein the interior face sheet is perforated and the backing sheet is substantially impervious.

The pair of monolithic doors are each adapted to conform to one of the opposed first and second door openings. Each door comprises an interior face sheet of material, an outer sheet of material, and a backing sheet of material interposed between the interior face sheet and the outer sheet. The backing sheet of material is separated from the interior face sheet by a second cellular core and from the outer sheet by a third cellular core.

The aircraft engine further includes an actuator system for deploying the doors by pivoting each door away from the barrel, and for stowing the doors by pivoting each door toward the barrel and in alignment with the openings

These and other important aspects of the present invention are described more fully in the detailed description below.

### BRIEF DESCRIPTION OF THE DRAWINGS

FIG. 1 is a perspective view of a jet aircraft engine including an improved monolithic thrust reverser constructed according to principles of the present invention;

FIG. 2 is a perspective view of the thrust reverser of FIG. 1 separated from the aircraft engine and illustrating thrust reverser doors in a stowed position;

FIG. 3 s a perspective view of the thrust reverser of FIG. 2 illustrating the thrust reverser doors in a deployed position;

FIG. 4 is a perspective view of a monolithic fan duct barrel of the thrust reverser of FIG. 1, wherein the fan duct barrel comprises an annular wall with a forward section, an aft section, and a door section between the forward and aft sections;

FIG. 5 is a plan view of the monolithic fan duct barrel of FIG. 4;

FIG. 6 is a side elevation view of the monolithic fan duct barrel of FIG. 4;

FIG. 7 is a cross-sectional view of the aft section of the annular wall of the fan duct barrel of FIG. 4;

FIG. 8 is a perspective view of the thrust reverser of FIG. 2, illustrated with various structural components surrounding the monolithic fan duct barrel;

FIG. 9 is an aft perspective view of a door of the thrust reverser of FIG. 2;

FIG. 10 is a forward perspective view of the door of FIG. 9;

FIG. 11 is an exploded fragmentary view of the aft section of FIG. 7 and one of the thrust reverser doors of FIG. 3, illustrating three layers separated by cellular cores; and

FIG. 12 is a side elevation view of the thrust reverser door illustrated in FIG. 9.

### DETAILED DESCRIPTION

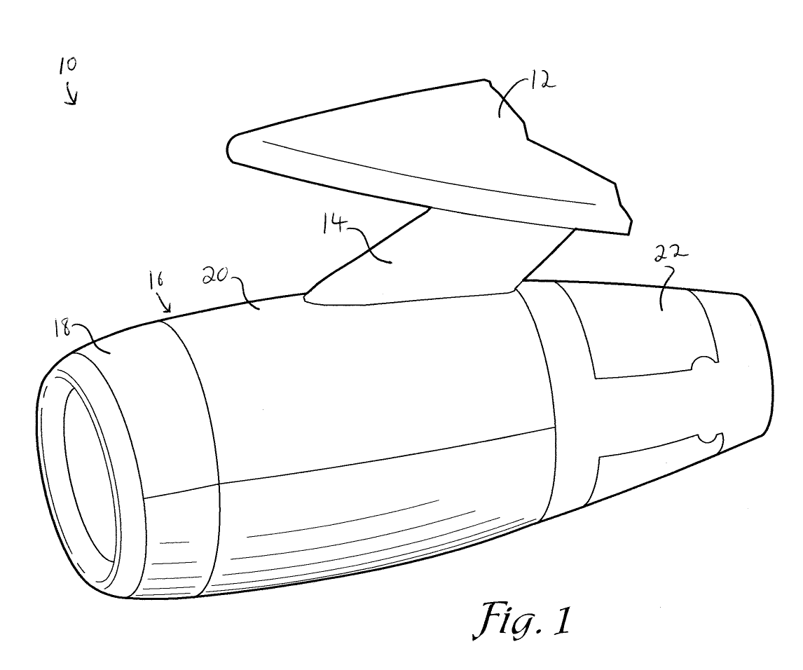

An aircraft engine embodying principles of the present teachings is illustrated in FIG. 1 and designated generally by the reference numeral 10. The aircraft engine 10 is secured to an aircraft wing 12 by a strut 14 and includes a nacelle 16 surrounding a jet engine (not shown). The nacelle 16 comprises an inlet 18, a fan cowl 20, and a thrust reverser 22. An annular outer surface of the nacelle 16 is substantially uninterrupted from the inlet 18 to the thrust reverser 22 (except when thrust reverser doors are deployed, as explained below). The fan cowl 20 is spaced radially outwardly from an outer wall of the engine, such that the engine wall and the fan cowl 20 define an annular fan air duct inside the nacelle 16 for the rearward flow of air.

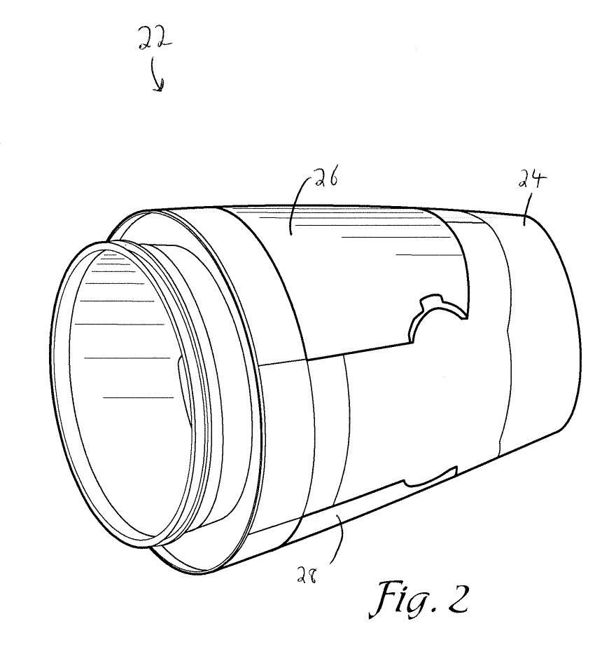

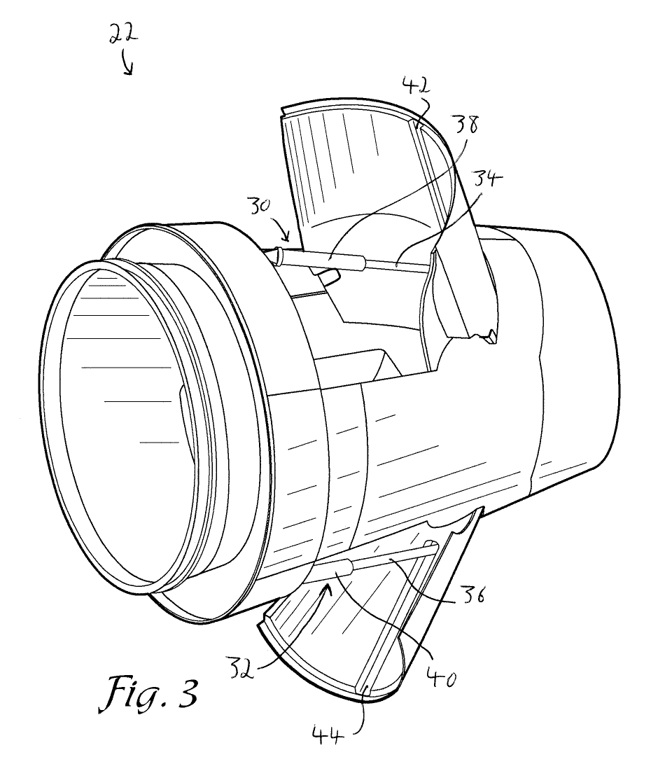

The thrust reverser 22 is illustrated in greater detail in FIG. 2. The thrust reverser 22 generally compromises a monolithic fan duct barrel 24 and a plurality of thrust reverser doors, such as the illustrated upper door 26 and lower door 28. The upper door 26 and the lower door 28 are pivotally mounted on the thrust reverser 22 to be moveable between a stowed position (FIG. 2) and a deployed position (FIG. 3) by an actuator system.

As illustrated in FIG. 3, the actuator system includes two actuators 30,32, wherein each actuator 30,32 includes an actuating rod 34,36 and a hydraulic cylinder 38,40, respectively. The actuating rods 34,36 are pivotally secured to the doors 26,28, respectively, and fit in an upper actuator trough 42 and a lower actuator trough 44 when the doors 26,28 are in the stowed position. The doors 26,28 move to the deployed position when the hydraulic cylinders 38,40 force the actuating rods 34,36 to extend rearwardly, wherein forward edges of the doors 26,28 move from a first position substantially flush with the outer surface of the nacelle 16 (FIG. 1) to a second, radially outward position (FIG. 3). The hydraulic cylinders 38,40 and actuating rods 34,36 may be substantially conventional in nature and therefore will not be described in detail. Furthermore, the thrust reverser 22 is not limited to the actuator system described and illustrated herein, but may employ other, equally preferred systems or components operable to move the doors 26,28 between the stowed position and the deployed position.

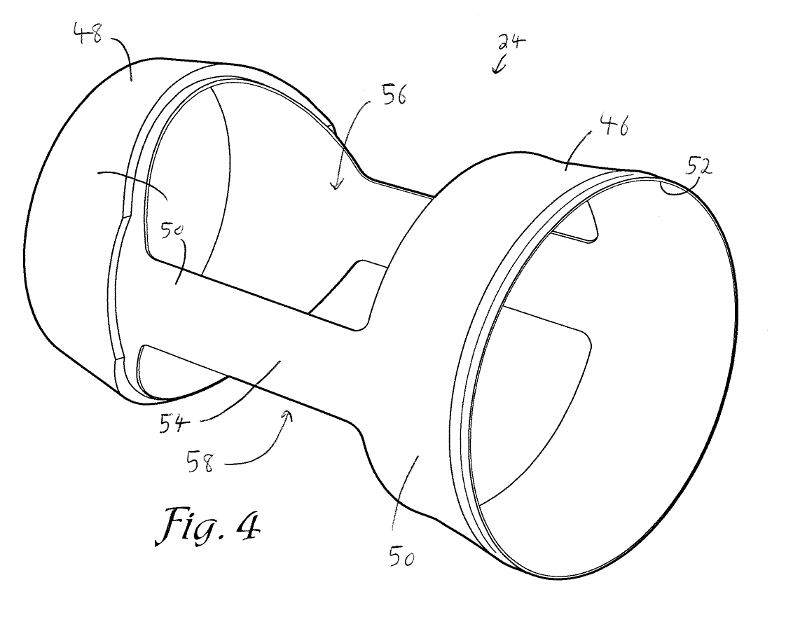

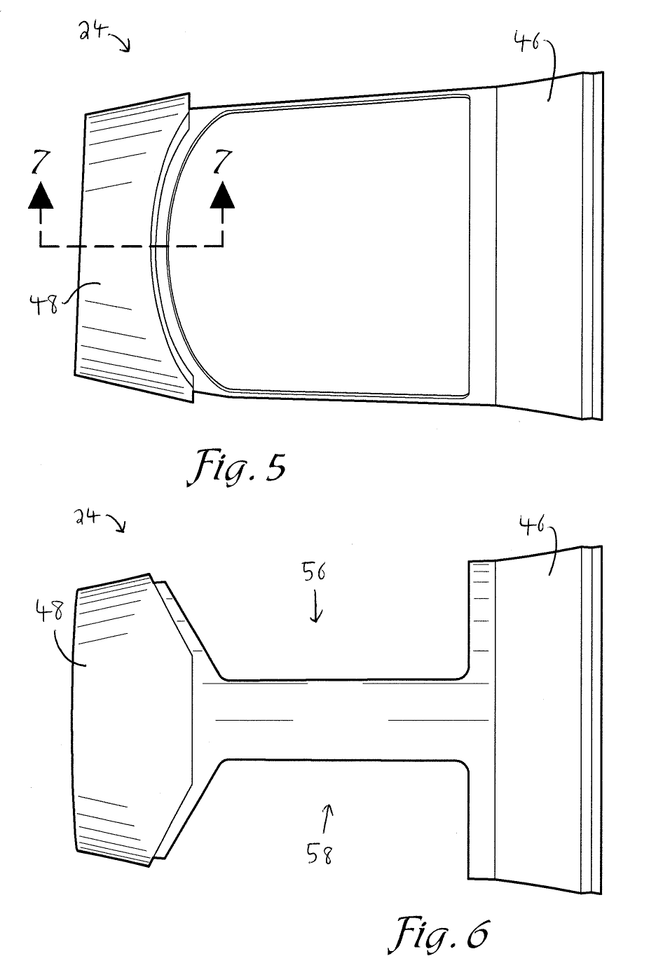

The monolithic fan duct barrel 24 is illustrated in FIG. 4. The barrel 24 is substantially annular and tapered such that a forward section 46 generally presents a larger diameter than an aft section 48. While the size of the barrel 24 is not critical to the operation of the thrust reverser 22, the length of the illustrated monolithic fan duct barrel is preferably within the range of about 50 inches to about 100 inches, more preferably within the range of about 60 inches to about 90 inches, even more preferably within the range of about 70 inches to about 80 inches, and most preferably about 75 inches. A diameter of a broadest portion of the forward section 38 is preferably within the range of about 50 inches to about 70 inches, more preferably within the range of about 55 inches to about 65 inches, even more preferably within the range of about 58 inches to about 62 inches, most preferably about 60 inches. A diameter of a narrowest portion of the aft section 40 is preferably within the range of about 30 inches to about 50 inches, more preferably within the range of about 35 inches to about 45 inches, even more preferably within the range of about 38 inches to about 42 inches, and most preferably about 40 inches.

The monolithic fan duct barrel 24 compromises an annular wall 50. The annular wall 50 defines the forward section 46, the aft section 48, and a door section 54 located between the forward section 46 and the aft section 48. The forward section 46 and the aft section 48 are continuously annular, wherein each presents an uninterrupted circular configuration. The forward section 46 further presents a forwardly-extending annular flange 52 for connecting to surrounding structural elements (see FIG. 8), to the fan cowl 20, or both. The illustrated flange 52 defines a loop that is slightly smaller in diameter than an outer end of the forward section 46 of the annular wall 50 to which it is attached. The aft section 48 defines a final nozzle section of the aircraft engine 10. The fan cowl 20 defines a forward section of the fan air duct while the fan duct barrel 24 defines an aft section of the fan air duct.

The door section 54 is located between the forward section 46 and the aft section 48 and presents a plurality of door openings 56,58. The illustrated door openings 56,58, are circumferentially arranged in an opposed configuration, and each opening 56,58 radially spans a section of the wall 50 greater than about one-fourth and less than one-half of a total circumference of the barrel 24. While the illustrated fan duct barrel 24 presents only two door openings 56,58, it is within the ambit of the present invention to include more or fewer door openings, such as, for example, one, three, four, five, or six openings.

As illustrated, the entire wall 50 of the monolithic fan duct barrel 24 is manufactured as a single, continuous piece. This monolithic construction eliminates the need to bolt, rivet, weld, or otherwise attached different sections of the barrel to one another. This, in turn, reduces the overall weight of the barrel, simplifies the assembly process, increases the available acoustic area of the barrel 24, and augments the overall structural integrity of the barrel 24.

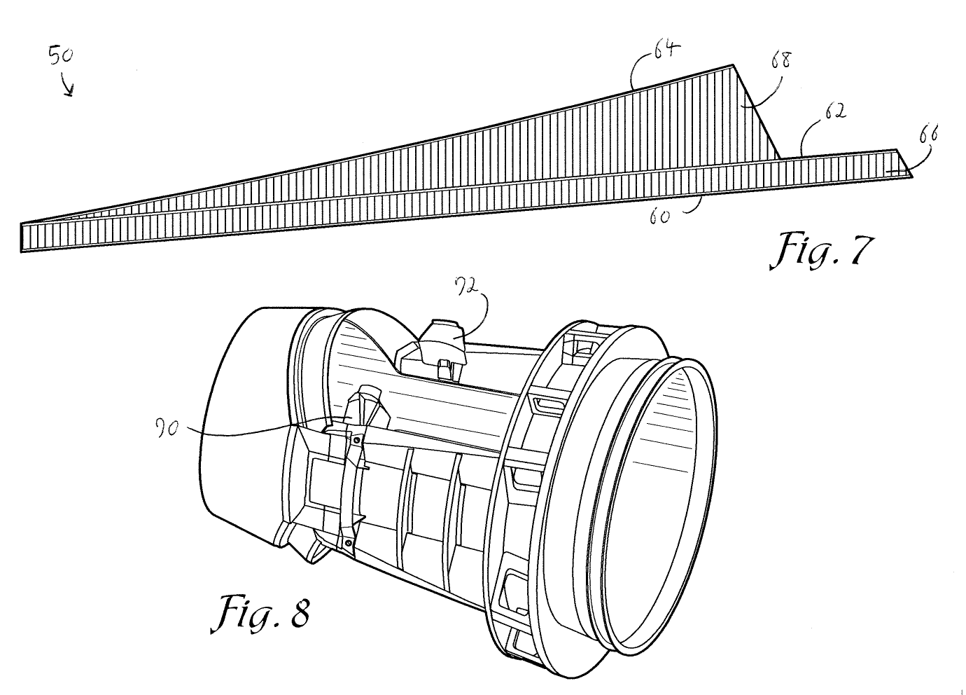

The annular wall 50 comprises two sheets of material separated radially by cellular cores. As illustrated in FIGS. 7 and 11, the wall 50 includes an interior face sheet 60 radially separated from a backing sheet 62 by a first cellular core 66. The interior face sheet 60 is the radially innermost surface of the fan duct barrel 24 and forms part of the annular fan air duct defined by the cowl 20 and the engine wall. The interior face sheet 52 and backing sheet 62 may be fabricated in a conventional manner of commonly used facing sheet materials such as aluminum sheet or laminated layers of polymide, epoxy glass, graphite epoxy, or similar materials bonded together using an epoxy, bismaleimide resin, or other suitable adhesives in a conventional manner.

The interior face sheet 60 presents a plurality of perforations, while the backing sheet 62 is substantially impervious. The perforations in the interior face sheet 60 are preferably within the range of from about 0.020 to about 0.070 inches, more preferably from about 0.030 to about 0.060 inches, and most preferably from about 0.040-0.050 inches. A percent open area (“POA”) of the interior face sheet 60 is preferably within the range of from about 1% to about 40%, more preferably from about 3% to about 30%, even more preferably from about 5% to about 20%, and most preferably from about 7% to about 14%. Each perforation forms an acoustic path to a closed cell structure to provide acoustic resistance.

The first cellular core 66 presents a plurality of uniform or nonuniform cells defined by cell walls that are substantially normal to the interior face sheet 60 and the backing sheet 62. The interior face sheet 60, backing sheet 62, and cellular core 66 may be constructed and assembled according to the teachings of U.S. patent application Nos. 6,051,302 and 6,557,779, incorporated herein by reference.

The cellular cores 66,68 may have any commonly used cellular core designs such as flexcore, hexcore or the like with cell sizes of approximately ⅜ of an inch. The cores 66,68 may be formed of typical cellular material such as aluminum, fiberglass or aramid paper/phenolic resin. Furthermore, the cellular cores 66,68 preferably present a honeycomb structure, wherein cell walls join to form a plurality of uniformly-sized and shaped cells. Alternatively, the cellular cores 66,68 may present cells of differing sizes, differing shapes, or both.

The aft section 48 of the fan duct barrel 24 further includes an outer sheet of material 64 that is spaced radially outwardly from the backing sheet 62. The outer sheet 64 is separated from the backing sheet 62 by a second cellular core 68, illustrated in FIGS. 7 and 11. A forward portion of the core 68 is thicker than an aft portion of the core 68, causing the outer sheet 64 to taper inwardly. The second cellular core 68 may be similar or identical to the first cellular core 66, and the outer sheet 64 may be similar or identical to the backing sheet 62. The outer sheet 64 presents an outer surface that is flush with an outer surface of the doors 26,28 and other structural components surrounding the monolithic fan duct barrel 20. As illustrated in FIG. 11, the interior face sheet 60 is perforated while the backing sheet 62 is substantially impervious, thus providing acoustic attenuation.

As illustrated in FIG. 8 various thrust reverser structural elements are mounted on the fan duct barrel 24 and support doors 26,28 and an outer skin (FIGS. 1-3). The structural components and outer skin maybe conventional in nature and therefore are not described in detail. The structural elements include a first pivotal mount 70 and a second pivotal mount 72 that attach to the upper door 26 and pivotally attach to thrust reverser structural elements to allow the door 26 to pivot when actuated by the actuator 30, as illustrated in FIG. 3 and discussed above. A second pair of pivotal mounts (not illustrated) are attached to the lower door 28. The upper door 26 and the lower door 28 are substantially identical in form and function and therefore only upper door 26 will be described herein in detail, with the understanding that the lower door 28 is constructed in a manner similar to the upper door 26.

As illustrated in FIG. 1 and FIG. 3, the upper door 26 and the lower door 28 generally are located on the illustrated thrust reverser 22 as mirror images separated vertically in a clamshell arrangement. The door 26 conforms generally to the shape of the first door opening 56 of the door section 54. As explained previously, the door 26 is pivotal between a stowed position as illustrated in FIG. 1 and FIG. 2, to a deployed position as illustrated in FIG. 3. When in the deployed position, the doors 26,28 diverge forwardly to direct the flow of the jet stream in a generally forward direction, thereby reversing the thrust of the aircraft engine 10.

When moved from the stowed position to the deployed position, the doors 26,28 pivot such that an aft portion of the door moves inwardly toward the engine wall while a forward portion of each door moves outwardly, thereby diverting air from the fan air duct generally forwardly to reverse the thrust of the engine, as explained above.

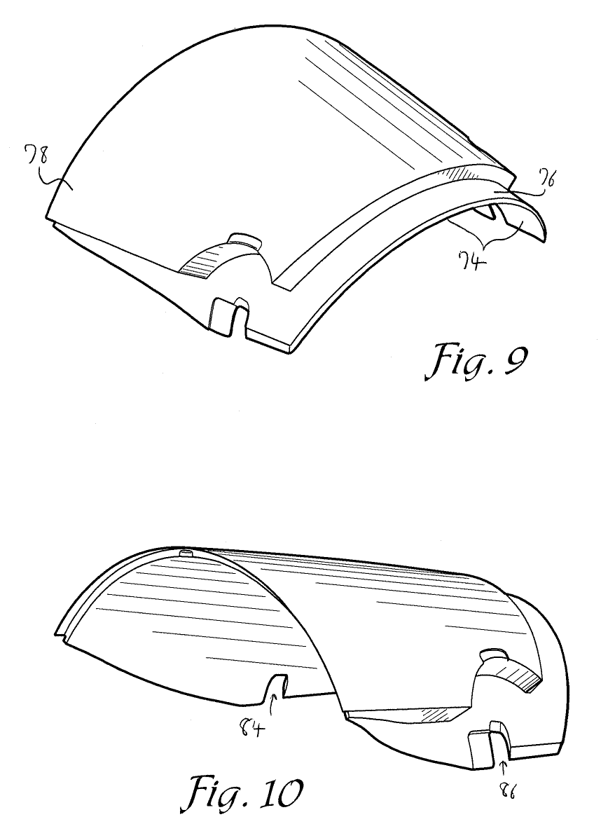

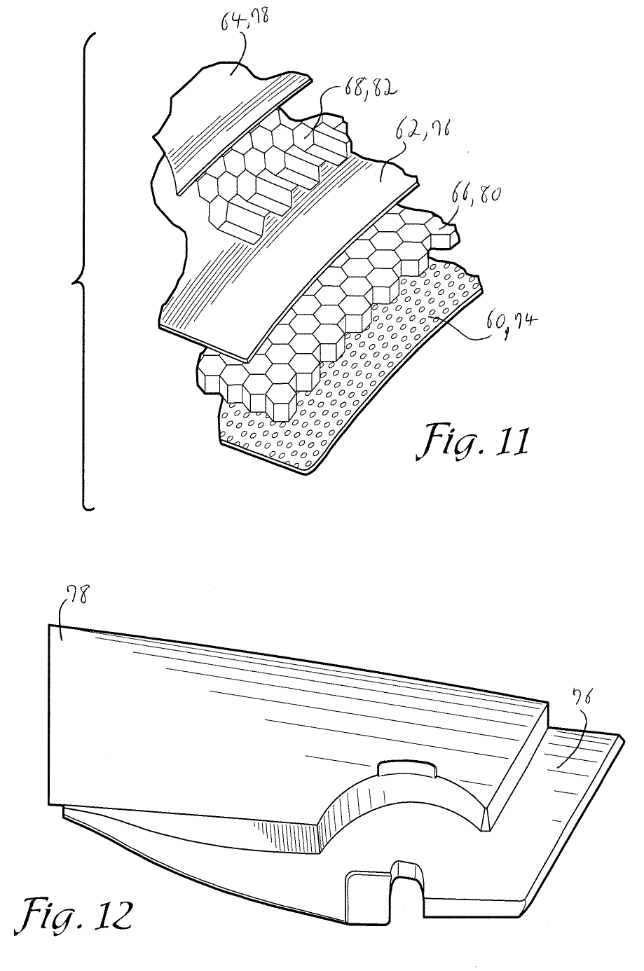

Referring particularly to FIGS. 9-12, each door 26,28 includes an interior face sheet 74 separated from a backing sheet 76 by a first cellular core 80, and an outer sheet 78 separated from a backing sheet 76 by a second cellular core 82. The interior face sheet 74, backing sheet 76, outer sheet 78, first cellular core 80, and second cellular core 82 of the door 26 may be substantially similar or identical to analogous sheets and cores of the wall 50. Thus, the interior face sheet 74 of the door 26 is perforated, as illustrated in FIG. 11, while the backing sheet 76 of the door 26 is substantially impervious.

A first mounting recess 76 and a second mounting recess 78 are used to secure the door 26 to the first and second pivotal mounts 62,64. Furthermore, the outer sheet 78 and second cellular core 82 are shaped such that the outer sheet 78 is substantially flush with an outer surface of the thrust reverser 22 when the door 26 is in the stowed position, and substantially conforms to the opening 56.

In use, the doors 26,28 are deployed when the hydraulic cylinders 38,40 are actuated to force the actuator rods 34,36 to extend in the aft direction, thereby causing the doors 26,28 to pivot toward the deployed position. Stowing the doors involves actuating hydraulic cylinders 38,40 to retract the actuator rods 34,36 forwardly causing the doors 26,28 to pivot to the stowed position.

Although the invention has been described with reference to the preferred embodiments illustrated in the attached drawings, it is noted that equivalents may be employed and substitutions made herein without departing from the scope of the invention as recited in the claims. It will be appreciated, for example, that the outer sheet 78 and the second cellular core 82 may be omitted from either or both of the doors 26,28 with departing from the spirit and scope of the invention.

Having thus described a preferred embodiment of the invention, what is claimed as new and desired to be protected by Letters Patent includes the following:

1. A thrust reverser for a jet engine, the thrust reverser comprising:
a monolithic fan duct barrel with an annular wall that defines a plurality of door openings, wherein the wall includes an interior face sheet and a backing sheet radially separated by a first cellular core.

2. The thrust reverser as set forth in claim 1, wherein the interior face sheet includes a plurality of perforations and the backing sheet is substantially impervious.

3. The thrust reverser as set forth in claim 1, wherein the annular wall includes a continuously annular forward section, a continuously annular aft section, and a door section between the forward section and the aft section, wherein the door section defines the door openings.

4. The thrust reverser as set forth in claim 3, wherein the annular wall further comprises an outer sheet corresponding to the aft section, wherein the outer sheet is radially separated from the backing sheet by a second cellular core.

5. The thrust reverser as set forth in claim 4, wherein the first and second cores each comprises a thermally conductive nonmetallic carbon pitch fiber honeycomb structure.

6. The thrust reverser as set forth in claim 4, wherein the face sheet, the backing sheet, and the outer sheet each comprises a plurality of laminated layers of material.

7. The thrust reverser as set forth in claim 1, further comprising a plurality of thrust reverser doors each associated with one of the plurality of door openings, an interior face sheet and a backing sheet separated by a first cellular core, wherein at least one of the interior face sheet and the backing sheet substantially spans the associated door opening.

8. The thrust reverser as set forth in claim 7, wherein the interior face sheet of each door includes a plurality of perforations, and wherein the backing sheet of each door is substantially impervious.

9. The thrust reverser as set forth in claim 7, further comprising a plurality of actuators, wherein each actuator is operable to cause a door to move from a stowed position to a deployed position, and from the deployed position to the stowed position.

10. The thrust reverser as set forth in claim 7, wherein each door further comprises an outer sheet separated from the backing sheet of the door by a second cellular core.

11. The thrust reverser as set forth in claim 10, wherein the outer sheet is substantially the same size and shape as its respective door opening.

12. The thrust reverser as set forth in claim 11, wherein each door opening is greater than one-fourth of a total circumference of the wall.

13. The thrust reverser as set forth in claim 10, wherein each door is pivotable between a stowed position and a deployed position, such that when in the stowed position each door prevents air flow through its respective door opening, and when in the deployed position each door causes air flowing through the fan duct barrel to flow through its respective door opening in an at least partially forward direction.

14. The thrust reverser as set forth in claim 1, wherein the fan duct barrel has a length within the range of about 50 inches to about 100 inches, a forward section with a diameter within the range of about 50 inches to about 70 inches, and an aft section with a diameter within the range of about 30 inches to about 50 inches.

15. The thrust reverser as set forth in claim 14, wherein the length is within the range of about 60 inches to about 90 inches, the forward section diameter is within the range of about 55 inches to about 65 inches, and the aft section diameter is within the range of about 35 inches to about 45 inches.

16. The thrust reverser as set forth in claim 15, wherein the length is within the range of about 70 inches to about 80 inches, the forward section diameter is within the range of about 58 inches to about 62 inches, and the aft section diameter is within the range of about 38 inches to about 42 inches.

17. A nacelle for a jet engine, the nacelle comprising:
a fan cowl defining a first portion of a fan duct; and
a monolithic fan duct barrel with a wall that defines a second portion of the fan duct and defines a plurality of door openings, wherein the wall includes a continuously annular forward section, a continuously annular aft section, and a door section between the forward section and the aft section, wherein the door section defines the door openings, and wherein the wall includes an interior face sheet and a backing sheet radially separated by a first cellular core.

18. The thrust reverser as set forth in claim 17, further comprising a plurality of thrust reverser doors each associated with one of the plurality of door openings, wherein each door comprises an interior face sheet and a backing sheet separated by a first cellular core.

19. The thrust reverser as set forth in claim 18, wherein each door further comprises an outer sheet separated from the inner panel by a second cellular core.

20. The thrust reverser as set forth in claim 19, wherein the interior face sheet of the wall and the interior face sheet of each of the doors includes a plurality of perforations, and wherein the backing sheet of the wall and the backing sheet of each of the doors is substantially impervious.

21. The thrust reverser as set forth in claim 19, wherein the outer sheet of each door is substantially the same size and shape as its respective door opening.

22. The thrust reverser as set forth in claim 21, wherein each door opening is greater than one-fourth of a total circumference of the wall.

23. An aircraft engine comprising:
a jet engine;
a nacelle at least partially enclosing the engine, wherein the nacelle includes an aft thrust reverser including
a monolithic fan duct barrel with an annular wall presenting opposed first and second door openings, the wall including an interior face sheet of material and a backing sheet of material separated by a first cellular core, wherein the interior face sheet is perforated and the backing sheet is substantially impervious, and
a pair of monolithic doors each adapted to conform to one of the opposed first and second door openings, wherein each door comprises an interior face sheet of material, an outer sheet of material, and a backing sheet of material interposed between the interior face sheet and the outer sheet, wherein the backing sheet of material is separated from the interior face sheet by a second cellular core and from the outer sheet by a third cellular core; and
an actuator system for deploying the doors by pivoting each door away from the barrel, and for stowing the doors by pivoting each door toward the barrel and in alignment with the openings.

24. The power plant as set forth in claim 23, wherein the monolithic fan duct barrel wall includes an outer sheet of material located radially outwardly of the backing sheet of the wall, wherein the third sheet is impervious and is separated from the outer sheet of material by a fourth cellular core.

25. The thrust reverser as set forth in claim 23, wherein each door opening is greater than one-fourth of a total circumference of the wall.

26. A nacelle for an aircraft engine, the nacelle comprising:
a fan cowl defining a first portion of a fan duct; and
a monolithic fan duct barrel with a wall that defines a second portion of the fan duct and defines a plurality of door openings, wherein the wall includes a continuously annular forward section, a continuously annular aft section, and a door section between the forward section and the aft section, wherein the door section defines the door openings.
